(19) United States
(12) Patent Application Publication
(10) Pub. No.: US 2010/0095548 A1
(43) Pub. Date: Apr. 22, 2010

(54) HEAT EXCHANGER MODULE AND DUCTLESS DRYER HAVING THE SAME

(75) Inventors: Yang-Ho Kim, Gyeongsangnam-Do (KR); Seung-Phyo Ahn, Gyeongsangnam-Do (KR); Sang-Ik Lee, Gyeongsangnam-Do (KR); Byeong-Jo Ryoo, Gyeongsangnam-Do (KR); Sung-Ho Song, Gyeongsangnam-Do (KR); Han-Yong Jung, Gyeongsangnam-Do (KR); Jae-Hyuk Wee, Gyeongsangnam-Do (KR); Yoon-Seob Eom, Gyeongsangnam-Do (KR)

Correspondence Address: BIRCH STEWART KOLASCH & BIRCH, PO BOX 747, FALLS CHURCH, VA, 22040-0747, US

(73) Assignee: LG Electrics Inc, Seoul (KR)

(21) Appl. No.: 12/528,130

(22) PCT Filed: Feb. 19, 2008
(86) PCT No.: PCT/KR08/00971

§ 371 Date: Aug. 21, 2009

(30) Foreign Application Priority Data
Feb. 23, 2007 (KR) 10-2007-0018681

(51) Int. Cl. F26B 21/06; F26B 21/08; F28F 9/26; F26B 11/02

(52) U.S. Cl. 34/73; 34/79; 165/143; 34/132

(57) ABSTRACT

Disclosed is a ductless dryer having a heat exchanger module in accordance with the present invention. The heat exchanger module is configured to have a water-supplying inlet disposed at an outlet for air and to be provided with a sealing unit, a drain recess and a leakage preventing protrusion. Thus, a dehumidifying performance for humid air is enhanced. Accordingly, it is capable of preventing mold from being gathered on a wall of an installation space caused by exhausting the air in which moisture is not removed. Also, it is capable of preventing a user in the installation space from feeling unpleasant caused by exhausting the air in which the moisture is not removed to the installation space.

### TECHNICAL FIELD

The present invention relates to a ductless dryer having a heat exchanger module for removing moisture of humid air exhausted after laundry is dried, the ductless dryer which is capable of enhancing a dehumidifying performance of the heat exchanger module.

### BACKGROUND ART

Generally, a clothes dryer is an apparatus performing a drying operation on wet laundry as objects to be dried by blowing hot air into a drum to absorb moisture from the laundry therewithin. Dryers can be categorized as exhausting type dryers and condensing type dryers depending on the method employed for dealing with the humid air generated as the laundry is dried by absorbing moisture therefrom.

In the exhausting type dryer, humid air exhausted from a drum is exhausted outside the dryer. However, an exhaust duct is required for exhausting the moisture evaporated from the laundry in the drum to the outside of the dryer, and especially, the exhaust duct should be installed being extended a long distance to the outside of a room or building, because products of combustion such as carbon monoxide etc. are exhausted together with the moisture.

Meanwhile, in the condensing type dryer, the moisture in the humid air exhausted from the drum is condensed at a heat exchanger module to remove the moisture therefrom, and the dried air is recirculated back into the drum. However, a condensing type dryer does not facilitate to use gas as a heating source because a closed loop may be formed due to the flowing of the drying air.

In a ductless dryer, these disadvantages of the exhausting type and the condensing type dryers may be improved upon. That is, the ductless dryer has a configuration that it is not required to have an exhaust duct for exhausting the moisture evaporated in the drum installed to be extended a long distance to the outside of the room and to recirculate the dried air back into the drum after condensing the humid air exhausted from the drum in the heat exchanger module to remove the moisture.

To this end, the ductless dryer includes the heat exchanger module for removing moisture of humid air exhausted after laundry is dried.

When the humid air is not properly dehumidified by the heat exchanger module, air in which moisture is not removed is exhausted, thereby gathering mold on a wall of an installation space. Also, since the air in which moisture is not removed is exhausted to the installation space, a user in the installation space may become unpleasant.

### DISCLOSURE OF THE INVENTION

### Technical Problem

Therefore, it is an object of the present invention to provide a heat exchanger module having an enhanced dehumidifying performance. Further, it is another object of the present invention to provide a ductless dryer having the heat exchanger module having the enhanced dehumidifying performance.

### Technical Solution

To achieve these objects, there is provided a heat exchanger module dehumidifying humid air flowing out of a drum in a water-cooling manner after laundry loaded in the drum is dried, wherein a water-supplying inlet of the heat exchanger module may be disposed at an outlet for dry air flowing out of the heat exchanger module after the humid air is dehumidified.

The heat exchanger module may comprise a first heat exchanger disposed at an inlet for the humid air, and a second heat exchanger disposed at the outlet for the dry air. The heat exchanger module may be operated in a counter(1 path) manner that water supplied to a tube of the second heat exchanger is discharged through a tube of the first heat exchanger.

Further, there is provided a ductless dryer comprising a main body, a drum rotatably installed at the main body, a hot air supply unit providing hot air into the drum, and a heat exchanger module dehumidifying humid air exhausted from the drum and comprising a case, first and second heat exchangers received in the case, and a sealing unit for preventing leakage of air passing through the first and second heat exchangers, wherein a water-supplying inlet of the heat exchanger module may be disposed at an outlet for dry air flowing out of the heat exchanger module after the humid air is dehumidified. Here, preferably, the first heat exchanger may be disposed at an inlet for the humid air and the second heat exchanger may be disposed at the outlet for the dry air, and water supplied to the second heat exchanger may be discharged out through the first heat exchanger.

### BRIEF DESCRIPTION OF THE DRAWINGS

FIG. 1 is a schematic view showing a ductless dryer in accordance with one embodiment of the present invention;

FIG. 2 is a planar view showing the ductless dryer of FIG. 1;

FIG. 3 is an extracted view of a heat exchanger module in FIG. 1;

FIG. 4 is a diagram showing a case having a drain recess and a leakage preventing protrusion of FIG. 3;

FIG. 5 is a diagram showing that a heat exchanger is mounted on the drain recess of FIG. 4;

FIG. 6 is a diagram showing a first variation of the drain recess of FIG. 4;

FIG. 7 is a diagram showing a second variation of the drain recess of FIG. 4;

FIG. 8 is a diagram showing a third variation of the drain recess of FIG. 4;

FIG. 9 is a perspective view showing that a heat exchanger is mounted in the leakage preventing protrusion of FIG. 3;

FIG. 10 is an enlarged view of the leakage preventing protrusion of FIG. 9;

FIG. 11 is a graph comparing a heat exchanging performance according to a manner for supplying water supplied to the heat exchanger module of FIG. 3;

FIG. 12 is a graph comparing a condensing performance according to a manner for supplying water supplied to the heat exchanger module of FIG. 3;

FIG. 13 is an enlarged view of a sealing unit of the heat exchanger module of FIG. 3;

FIG. 14 is a diagram showing a first variation of an insertion protrusion of the sealing unit of FIG. 13; and

FIG. 15 is a diagram showing a second variation of the insertion protrusion of the sealing unit of FIG. 13.

### MODES FOR CARRYING OUT THE PREFERRED EMBODIMENTS

Description will now be given in detail of the preferred embodiment of the present invention, examples of which are illustrated in the accompanying drawings.

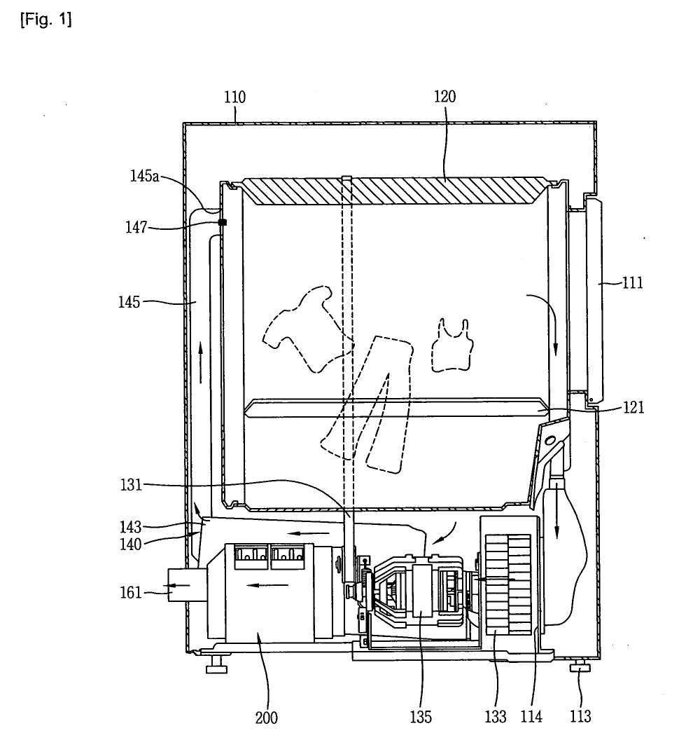

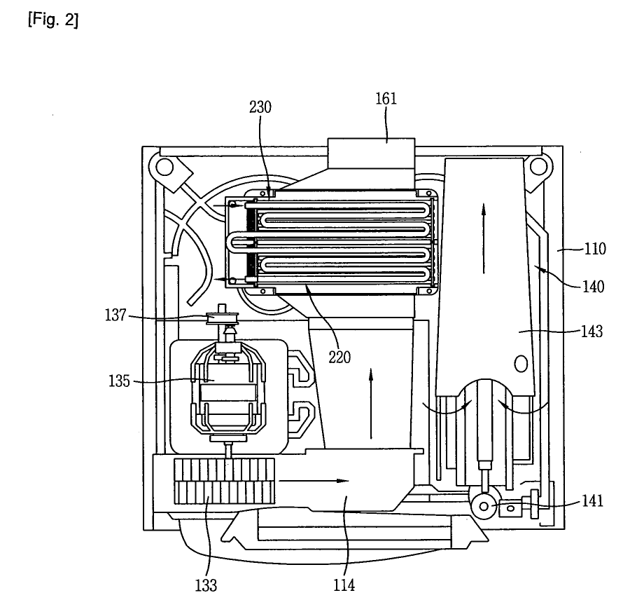

FIG. 1 is a schematic view showing a ductless dryer in accordance with one embodiment of the present invention, and FIG. 2 is a planar view showing the ductless dryer of FIG. 1. Arrows indicate flowing of air.

Referring to FIGS. 1 and 2, the ductless dryer in accordance with one embodiment of the present invention includes a main body 110, a drum 120 rotatably installed at the main body 110, a hot air supply unit 140 providing hot air into the drum 120 and a heat exchanger module 200 dehumidifying humid air exhausted from the drum 120 and having a water-supplying inlet for the dehumidifying operation disposed at an outlet for air.

A door 111 for putting clothes into the drum 120 is installed at a front side of the main body 110. And, a foot 113 supporting the main body 110 is installed at a lower side of the main body 110. The main body 110 has an inner space provided with a belt 131 rotating the drum 120, a fan 133 installed in a circulation duct 114, for providing a blowing force for air in the ductless dryer and a motor 135 providing the belt 131 and the fan 133 with a driving force.

A pulley 137 by which the belt 131 is stopped is installed at a rotation shaft of the motor 135. Here, the motors 135 may be configured to be plural so as to provide the belt 131 and the fan 133 with the driving force, respectively. And, the circulation duct 114 is provided with a filter (not shown) for filtering lint such as a fluff and a waste thread contained in hot and humid air flowing out of the drum 120.

The drum 120 is a container having an inner space for laundry, such as clothes. A plurality of lifters 121 for lifting the clothes are installed therein.

The hot air supply unit 140 includes a gas valve 141 by which gas is supplied or blocked, a gas combustor 143 for generating hot air by igniting gas exhausted from the gas valve 141 after mixing with external air, a hot air supply duct 145 connecting the gas combustor 143 with the drum 120 so as to supply the generated hot air to the drum 120, and a hot air temperature sensor 147 measuring a temperature of the hot air introduced into the drum 120.

The hot air supply unit 140 is provided with a flame rod extended from an edge portion of a flame so as to detect a flame current and indirectly measure the amount of carbon monoxide (CO) through a value of the flame current.

When the amount of the carbon monoxide measured by the flame rod corresponds to a reference value high enough to badly influence on a human body, the gas valve 141 is closed to stop the combustion and an alarming sound informs a user of necessity to ventilate.

The gas combustor 143 connected to the gas valve 141 mixes gas exhausted from the gas valve 141 with the external air for the combustion and heats air using the heat generated therefrom. Hot air generated therefrom is provided into the drum 120 through the hot air supply duct 145.

The hot air temperature sensor 147 is installed at a connect portion 145a connecting the hot air supply duct 145 with the drum 120. The hot air temperature sensor 147 may be provided plurally and be installed in the hot air supply duct 145.

In case that an air volume in the dryer is reduced, such as lint caught in the filter interrupts flowing of the air, the air cannot facilitates to flow due to too much laundry in the drum, the air volume in the dryer is reduced due to blocking of the duct connected to the outside, since the temperature of the air introduced into the drum 120 is higher than a reference temperature range (i.e., a temperature applied to prevent damage on laundry or a fire), the laundry may be damaged.

To prevent the aforementioned, the hot air supply unit 140 adjusts the gas valve 141 according to the air volume and controls the amount of gas supplied to the gas combustor 143. That is, if a temperature measured by the hot air temperature sensor 147 exceeds the reference temperature range resulting from that the air volume is reduced, the gas valve 141 is closed partially or entirely so as to reduce or block the gas introduced into the gas combustor 143. To this end, preferably, the gas valve 141 is implemented as a multiple stage solenoid valve by which an injection amount of gas can be minutely controlled.

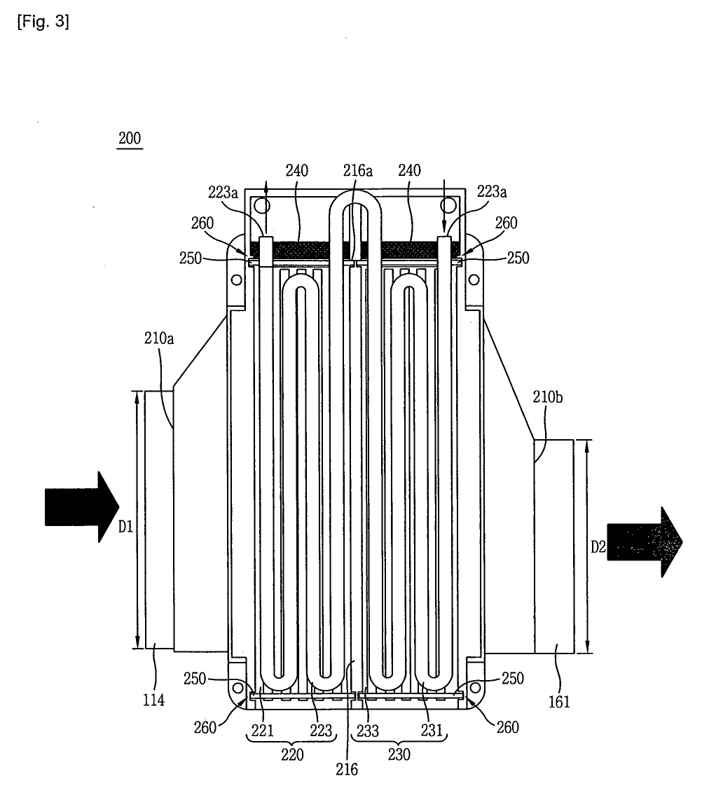

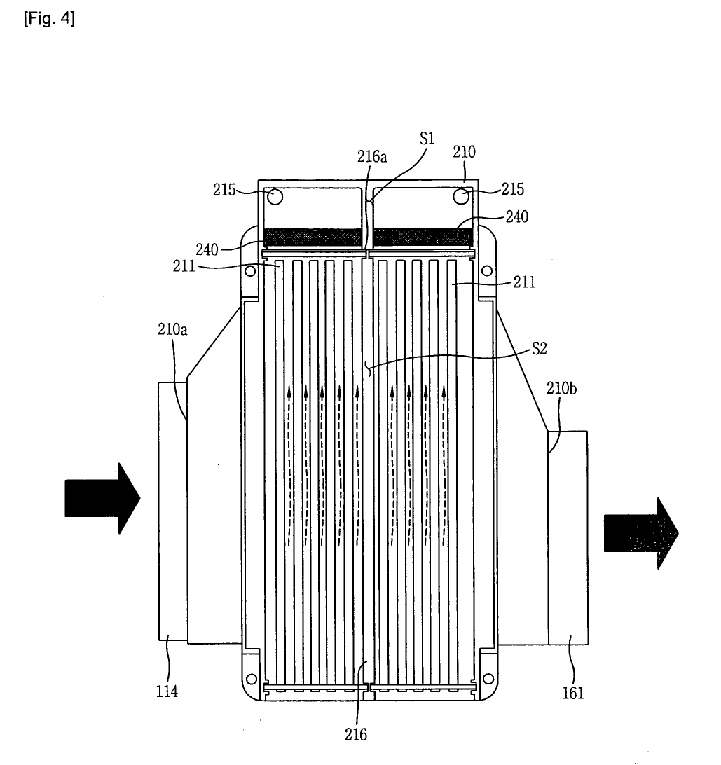

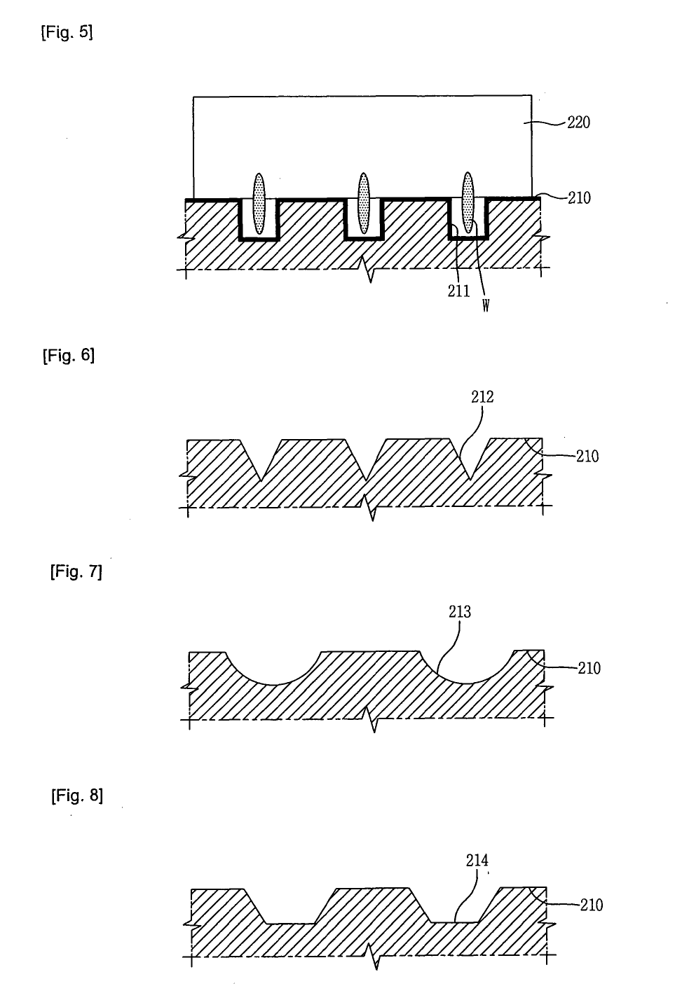

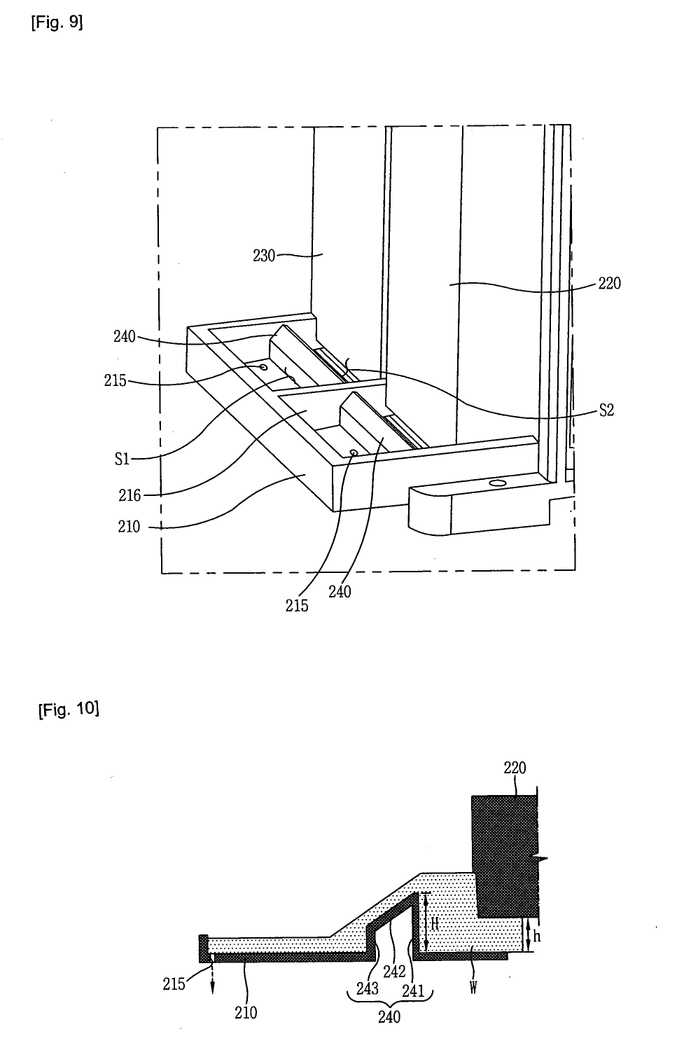

FIG. 3 is an extracted view of a heat exchanger module in FIG. 1, FIG. 4 is a diagram showing a case having a drain recess and a leakage preventing protrusion of FIG. 3, FIG. 5 is a diagram showing that a heat exchanger is mounted on the drain recess of FIG. 4, FIG. 6 is a diagram showing a first variation of the drain recess of FIG. 4, FIG. 7 is a diagram showing a second variation of the drain recess of FIG. 4, FIG. 8 is a diagram showing a third variation of the drain recess of FIG. 4, FIG. 9 is a perspective view showing that a heat exchanger is mounted in the leakage preventing protrusion of FIG. 3, and FIG. 10 is an enlarged view of the leakage preventing protrusion of FIG. 9. Here, thin arrows indicate flowing of water in a tube, thick arrows indicate flowing of air, and dotted-line arrows indicate flowing of water flowing down the drain recess.

Referring to FIGS. 3 and 4, the heat exchanger module 200 includes a case 210 forming a receiving space, at least one heat exchanger received in the case 210, a sealing unit for preventing leakage of air passing through the heat exchanger. Here, a diameter (D1) of an inlet 210a for air in the heat exchanger module 200 is larger than a diameter (D2) of an outlet 210b for the air therein, accordingly air containing moisture can remain in the heat exchanger module 200 for a longer time. Thus, the dehumidifying operation may be performed for a longer time, thereby enhancing a dehumidifying performance.

Referring to FIGS. 4 and 5, a plurality of drain recesses 211 having a section in a rectangular shape are formed at a bottom surface of the case 210 in a length direction. Heat exchangers 220, 230 are mounted on the drain recesses 211. Condensate water (W) dehumidified by the heat exchangers 220, 230 drops into the drain recesses 211. Here, since the case 210 is inclined toward a leakage preventing protrusion 240 by approximately 5°, the dropped condensate water flows to the leakage preventing protrusion 240 along the drain recess 211 in a direction of the dotted-line arrows. The condensate water flowing to the leakage preventing protrusion 240 rises up to a predetermined height (H, refer to FIG. 10) and then flows over the leakage preventing protrusion 240 so that the condensate water flows out through a drain opening 215. Because of the drain recesses 211, the condensate water does not remain on the bottom surface and can rapidly flow to the leakage preventing protrusion 240.

Referring to FIGS. 6 to 8, the drain recess 211 has a section that can be varied into a V-shaped groove 212, a semicircle-shaped groove 213 and a trapezoid-shaped groove 214.

Referring to FIGS. 9 and 10, the leakage preventing protrusion 240 is installed on the bottom surface of the case 210 in a width direction, thereby partitioning the receiving space of the case 210 into a left space (S1) and a right space (S2).

Two drain openings 215 are made on the bottom surface of the left space (S1). The drain openings 215 are connected to a drain pipe (not shown), accordingly the condensate water is discharged out therethrough.

Two heat exchangers are installed at the right space (S2) with being spaced from the bottom surface of the case 210 by a predetermined height. Here, a distance spaced between the bottom surface of the heat exchanger and the bottom surface of the case 210 is defined as a mounting height (h).

To this end, a separation wall 216 is extended from a central portion of the bottom surface of the case 210 in a length direction of the bottom surface. With the aforementioned configuration, the first heat exchanger 220 is putted on the separation wall 216 and the case 210 at the lower portion of the right space (S2). And, the second heat exchanger 230 is putted on the separation wall 216 and the case 210 at the upper portion of the right space (S2).

The leakage preventing protrusion 240 includes a first wall 241 protruded from the bottom surface of the case 210, a second wall 242 connected to the upper portion of the first wall 241 to be downwardly inclined, and a third wall 243 connecting the lower portion of the second wall 242 to the bottom surface of the case 210. Here, a height (H) of the first wall and the mounting height (h) of the heat exchanger satisfy a formula H/h>1. Preferably, the height (H) of the first wall and the mounting height (h) of the heat exchanger satisfy a formula H/h>1.3.

Because of the leakage preventing protrusion 240, a predetermined amount of condensate water having a predetermined height (H) always remains on the bottom surface of the case 210, accordingly it is capable of preventing the air from being leaked to the lower side of the heat exchanger. Also, when the water remains above the predetermined height (H), the water can be easily drained along the inclined second wall 242. Accordingly, it is capable of preventing the air from being leaked to the lower side of the heat exchanger, thereby enhancing the dehumidifying performance of the heat exchanger module.

Referring to FIG. 3, the heat exchanger includes the first heat exchanger 220 and the second heat exchanger 230. The heat exchanger may be configured with one heat exchanger, or with three or more heat exchangers, if necessary.

The first heat exchanger 220 is composed of a fin 221 and a tube 223. In the first heat exchanger 220, hot and humid air flowing out of the drum 120 is condensed by low-temperature water and dried by a heat exchanging manner between air and water. The first heat exchanger 220 is installed at a left side of the case 210 (refer to FIG. 1) so as to be located in an outlet end of the circulation duct 114 (refer to FIG. 2) connected to the drum 120.

The fin 221 is implemented as a plurality of thin plates stacked to each other with a minute gap therebetween so as to pass through the hot and humid air by vertically contacting thereto. Here, the thin plate is formed by a metallic material having an excellent conductivity.

The low-temperature (22° C.) water is circulated in the tube 223. And, the tube 223 is penetratingly formed at the fin 221 in a reciprocating manner.

Likewise the first heat exchanger 220, the second heat exchanger 230 is composed of a fin 231 and a tube 233. In the second heat exchanger 230, the dehumidified air flowing out of the first heat exchanger 220 is condensed by the low-temperature water and dried once more by the heat exchanging manner between air and water. The second heat exchanger 230 is installed at a right side of the case 210 so as to be located in an inlet end of the exhaust duct 161 (refer to FIG. 1).

The fin 231 is implemented as the plurality of thin plates stacked to each other with the minute gap therebetween so as to pass through the hot and humid air by vertically contacting thereto. Here, the thin plate is formed by a metallic material having the excellent conductivity.

The low-temperature (22° C.) water is circulated in the tube 233. And, the tube 233 is penetratingly formed at the fin 231 in the reciprocating manner.

And, the tube 223 of the first heat exchanger 220 and the tube 233 of the second heat exchanger 230 are connected with each other at a middle position between the first heat exchanger 220 and the second heat exchanger 230.

And, an inlet 233a of the tube 233 of the second heat exchanger 230 and an outlet 223a of the tube 223 of the first heat exchanger 220 are connected to a water hose (not shown) connected to an external water supplying source so as to receive water from the outside.

With the aforementioned configuration, the water introduced into the inlet 233a of the tube 233 of the second heat exchanger 230, a water-supplying inlet, through the water hose passes through the tubes 233, 223 and then cools the fin 231 of the second heat exchanger 230 and the fin 221 of the first heat exchanger 220. And after, the water flows into the water hose through the outlet 223a of the tube 223 of the first heat exchanger 220, a draining outlet. As such, when the water-supplying inlet is disposed at the outlet for the air and the draining outlet is disposed at the inlet for the air, accordingly the water introduced into the water-supplying inlet flows into the water hose through the draining outlet. This manner is referred to as a “counter(1 path)”.

When the water-supplying inlet is disposed at the inlet for the air and the draining outlet is disposed at the outlet for the air, accordingly the water introduced into the water-supplying inlet flows into the water hose through the draining outlet. This manner is referred to as a “parallel(1 path)”.

When the first heat exchanger 220 and the second heat exchanger 230 are respectively provided with the water-supplying inlet and the draining outlet, and the water-supplying inlet is disposed at the outlet for the air and the draining outlet is disposed at the inlet for the air, accordingly the water respectively introduced into the water-supplying inlet flows into the water hose through each draining outlet. This manner is referred to as a “counter(2 path)”.

When the first heat exchanger 220 and the second heat exchanger 230 are respectively provided with the water-supplying inlet and the draining outlet, and the water-supplying inlet is disposed at the inlet for the air and the draining outlet is disposed at the outlet for the air, accordingly the water respectively introduced into the water-supplying inlet flows into the water hose through each draining outlet. This manner is referred to as a “parallel(2 path)”.

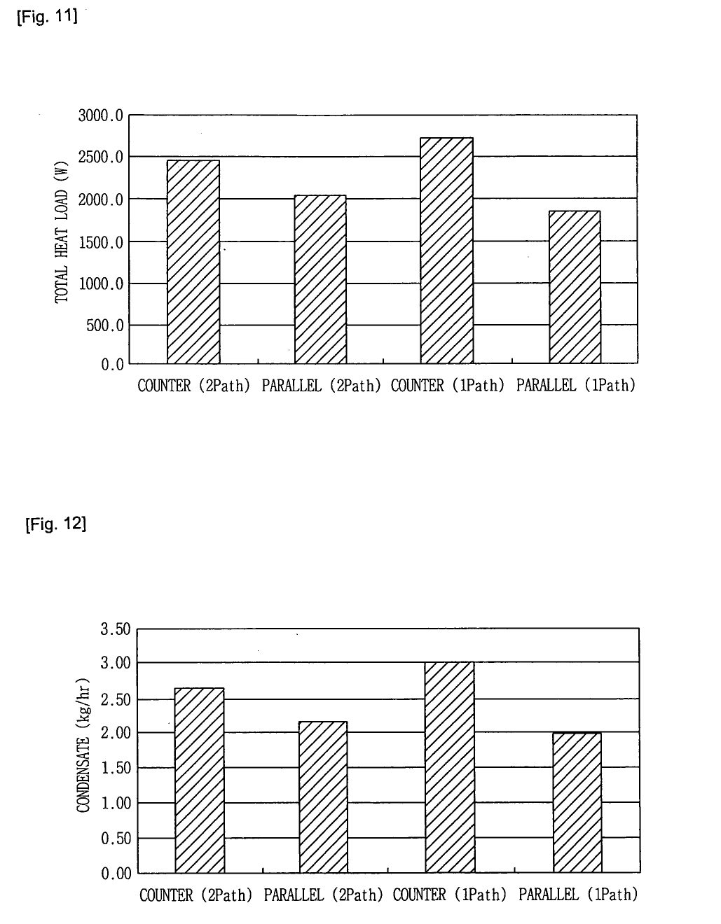

FIG. 11 is a graph comparing a heat exchanging performance according to a manner for supplying water supplied to the heat exchanger module of FIG. 3, and FIG. 12 is a graph comparing a condensing performance according to a manner for supplying water supplied to the heat exchanger module of FIG. 3.

Referring to FIG. 11, in case of the counter(2 path), a total heat load (W), a criterion of a heat exchanging performance, is 2500 W, in case of the parallel(2 path), the total heat load is 2000 W, in case of the counter(1 path), the total heat load is 2750 W, and in case of the parallel(1 path), the total heat load is 1800 W. Thus, the heat exchanging performance is superior to others in case of the counter(1 path).

Referring to FIG. 12, in case of the counter(2 path), a condensate (Kg/hr) that is a criterion of a condensing performance, is 2.6 Kg/hr. In case of the parallel(2 path), the condensate is 2.2 Kg/hr. In case of the counter(1 path), the condensate is 3.0 Kg/hr. And, in case of the parallel(1 path), the condensate is 2.0 Kg/hr. Thus, the condensing performance is superior to others in case of the counter(1 path).

In conclusion, when the water-supplying inlet for the dehumidifying operation is disposed at the outlet for the air, the heat exchanger module 200 performs the heat exchanging operation and the dehumidifying operation with the highest efficiency.

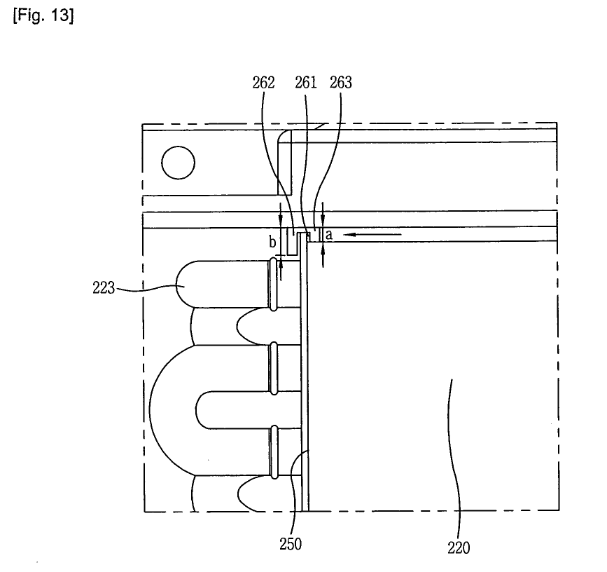

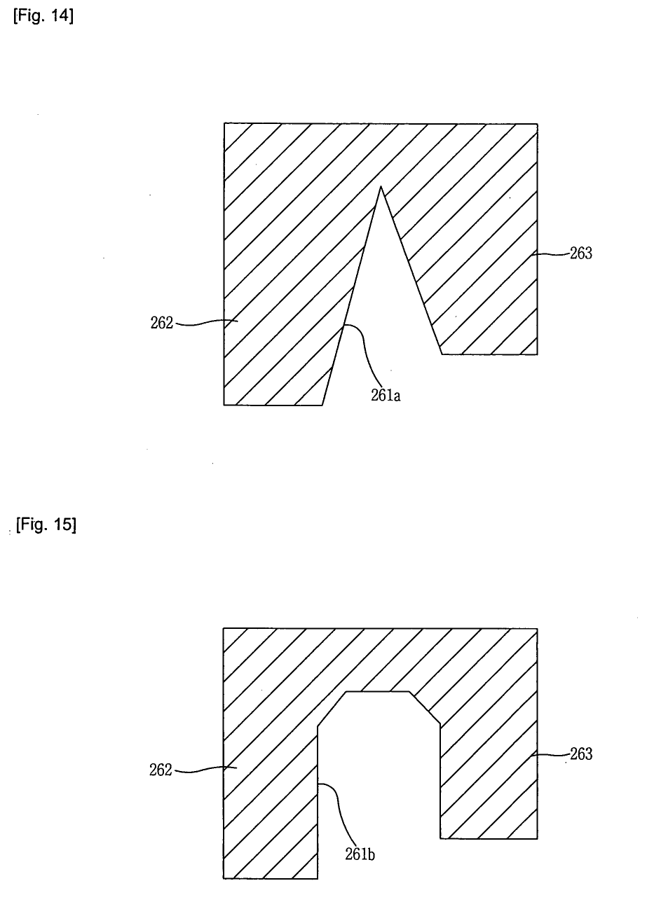

FIG. 13 is an enlarged view of a sealing unit of the heat exchanger module of FIG. 3, FIG. 14 is a diagram showing a first variation of an insertion protrusion of the sealing unit of FIG. 13, and FIG. 15 is a diagram showing a second variation of the insertion protrusion of the sealing unit of FIG. 13.

Referring to FIG. 3, the sealing unit includes side plates 250 formed at both lateral surfaces of the heat exchangers 220, 230, insertion protrusions 260 having grooves into which one side of each side plate 250 is inserted, and grooves 216a formed at the separation wall 216 so that the other side of the side plate 250 may be inserted thereinto. In this embodiment, since there are two heat exchangers 220, 230, the grooves 216a are formed at both lateral surfaces of the separation wall 216.

Referring to FIG. 13, the insertion protrusion 260 includes a left protrusion 262 protruded to a left side of the groove 261 and a right protrusion 263 protruded to a right side of the groove 261 so as to form the groove 261 into which the side plate 250 is inserted. Here, in order to prevent interference between the left protrusion 262 and the tube 223, a length (b) of the left protrusion 262 and a length (a) of the right protrusion 263 satisfy a formula 1<b/a<=2.

Referring to FIGS. 14 and 15, the groove 261 of the insertion protrusion 260 may have a section that can be varied into a triangle-shaped groove 261a or a trapezoid-shaped groove 261b. Because of the sealing unit, it is capable of preventing the air is leaked to a direction of an arrow (refer to FIG. 13), thereby being capable of enhancing the dehumidifying performance of the heat exchanger module 200.

In accordance with the ductless dryer having the heat exchanger module of the present invention, the heat exchanger module is configured to have the water-supplying inlet disposed at the outlet for the air and to be provided with the sealing unit, the drain groove and the leakage preventing protrusion. Thus, the dehumidifying performance for the humid air is enhanced. Accordingly, it is capable of preventing mold from being gathered on the wall of the installation space caused by exhausting the air in which moisture is not removed. Also, it is capable of preventing the user in the installation space from feeling unpleasant caused by exhausting the air in which the moisture is not removed to the installation space.

The ductless dryer in accordance with the present invention can be used domestically, commercially and industrially.

It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A heat exchanger module dehumidifying humid air flowing out of a drum in a water-cooling manner after laundry loaded in the drum is dried, wherein a water-supplying inlet thereof is disposed at an outlet for dry air flowing out of the heat exchanger module after the humid air is dehumidified.

2. The heat exchanger module of claim 1, wherein the heat exchanger module comprises:
a first heat exchanger disposed at an inlet for the humid air; and
a second heat exchanger disposed at the outlet for the dry air.

3. The heat exchanger module of claim 2, wherein the heat exchanger module is operated in a counter(1 path) manner that water supplied to a tube of the second heat exchanger is discharged through a tube of the first heat exchanger.

4. The heat exchanger module of claim 2, wherein a diameter of the inlet through which the humid air is introduced is larger than that of the outlet through which the dry air flows out.

5. The heat exchanger module of claim 1, wherein the heat exchanger module comprises:
a case forming a receiving space;
at least one heat exchanger received in the case; and
a sealing unit for preventing leakage of air passing through the heat exchanger.

6. The heat exchanger module of claim 5, wherein a draining groove is formed on a bottom surface of the case in a length direction.

7. The heat exchanger module of claim 5, wherein a leakage preventing protrusion is installed on a bottom surface of the case in a width direction.

8. The heat exchanger module of claim 7, wherein the leakage preventing protrusion partitions the receiving space of the case into a left space (S1) and a right space (S2).

9. The heat exchanger module of claim 7, wherein the leakage preventing protrusion comprises a first wall protruded from the bottom surface of the case, a second wall connected to an upper portion of the first wall to be downwardly inclined, and a third wall connecting the lower portion of the second wall to the bottom surface of the case.

10. The heat exchanger module of claim 9, wherein a separation wall on which one side of the heat exchanger is putted is installed thereat so that a predetermined mounting height (h) is provided between the bottom surface of the case and the bottom surface of the heat exchanger.

11. The heat exchanger module of claim 10, wherein the separation wall is extended from a central portion of the bottom surface of the case in a length direction of the bottom surface.

12. The heat exchanger module of claim 11, wherein a height (H) of the first wall and the mounting height (h) of the heat exchanger satisfy a formula H/h>1.

13. The heat exchanger module of claim 10, wherein the sealing unit comprises side plates formed at both lateral surfaces of the heat exchangers, insertion protrusions formed at the case and having grooves into which one side of each side plate is inserted, and grooves formed at the separation wall so as for the other side of the side plate to be inserted thereinto.

14. The heat exchanger module of claim 13, wherein the insertion protrusion comprises a left protrusion protruded at a left side of the groove and a right protrusion protruded at a right side thereof so as to form the groove.

15. A ductless dryer having the heat exchanger module of claim 1.

16. A ductless dryer comprising:
a main body;
a drum rotatably installed at the main body;
a hot air supply unit providing hot air into the drum; and
a heat exchanger module dehumidifying humid air exhausted from the drum and comprising a case, first and second heat exchangers received in the case, and a sealing unit for preventing leakage of air passing through the first and second heat exchangers,
wherein a water-supplying inlet of the heat exchanger module is disposed at an outlet for dry air flowing out of the heat exchanger module after the humid air is dehumidified.

17. The ductless dryer of claim 16, wherein the first heat exchanger is disposed at an inlet for the humid air and the second heat exchanger is disposed at the outlet for the dry air, and water supplied to the second heat exchanger is discharged out through the first heat exchanger.
